(19) United States
(12) Patent Application Publication
(10) Pub. No.: US 2014/0376977 A1
(43) Pub. Date: Dec. 25, 2014

(54) CLEANING WEB UNIT

(71) Applicant: Océ- Technologies B.V., Venlo (NL)

(72) Inventor: Johannes H.B. NABUURS, Venlo (NL)

(21) Appl. No.: 14/310,473

(22) Filed: Jun. 20, 2014

(30) Foreign Application Priority Data
Jun. 21, 2013 (EP) 13173236.4

(51) Int. Cl. G03G 15/20

(52) U.S. Cl. CPC G03G 21/0041
USPC 399/327

(57) ABSTRACT

A cleaning web unit is provided. The cleaning web unit includes a cleaning web, a web supply mechanism for supplying the cleaning web, a wind-up roller which supports the cleaning web at one end and is adapted for winding the cleaning web around the wind-up roller and a driving roller. The driving roller forms a web transporting pinch and has a surface which in operation is urged against a portion of the cleaning web in said web transporting pinch. The driving roller is adapted for transporting the cleaning web through the web transporting pinch, thereby winding the cleaning web around the wind-up roller.

### FIELD OF THE INVENTION

The present invention relates to a cleaning web unit. The present invention further relates to a method for transporting a cleaning web. The present invention further relates to a printing apparatus comprising the cleaning web unit of the present invention.

### BACKGROUND OF THE INVENTION

In a known printing apparatus a cleaning web unit is provided, comprising a cleaning web, a web supply mechanism and a wind-up roller for winding the cleaning web, which cleaning web may be used for cleaning a rotatable member of the printing apparatus. According to the prior art a winding mechanism rotates the wind-up roller over a constant angle in response to a web refreshing signal. The distance over which the cleaning web is transported varies depending on the amount of cleaning web, which is already wound around the wind-up roller. As a result the stepwise transport distance of the cleaning web increases along the refreshment step number of the cleaning web. Therefore the use of the cleaning web is not efficient and the end of the cleaning web is not accurately foreknown.

### SUMMARY OF THE INVENTION

It is accordingly an object of the present invention to provide a cleaning web unit, wherein the transport of the cleaning web can be accurately controlled.

This object is attained by a cleaning web unit, the cleaning web unit comprising: a cleaning web; a web supply mechanism for supplying the cleaning web; a wind-up roller which supports the cleaning web at one end and is adapted for winding the cleaning web around the wind-up roller; a driving roller having a surface which in operation is urged against a portion of the cleaning web, the driving roller being adapted for transporting the cleaning web, thereby winding the cleaning web around the wind-up roller, wherein the driving roller forms a web transporting pinch and wherein the driving roller is urged against said portion of the cleaning web in said web transporting pinch.

The driving roller is urged against a portion of the cleaning web in operation of the cleaning web unit. The driving roller forms a web transport pinch. The driving roller may form said web transport pinch in conjunction with the wind-up roller or with a supply roller or with a pinch roller. Said supply roller is part of the web supply mechanism and supports the cleaning web at another end in the form of a roll of cleaning web.

Said pinch roller may be any roller arranged adjacent to said driving roller and forming a web transporting pinch for transporting said cleaning web.

Said portion of the cleaning web is arranged in the web transport pinch. In case the driving roller in operation is driven (i.e. is rotated), the driving roller transports the cleaning web through the web transport pinch. As a result in conjunction with the wind-up roller the transported cleaning web is wound-up around the wind-up roller.

For example the wind-up roller may comprise a pre-tension mechanism, such as a torsional spring, which is adapted to pull the cleaning web on said one end. Said one end of the cleaning web may be fixed to the wind-up roller. As a result a cleaning web portion, which is transported by the driving roller through the web transport pinch, is accordingly and automatically winded around the wind-up roller due to a pre-tension provided by the pre-tension mechanism on said one end of the cleaning web.

The driving roller forming the web transport pinch provides both a simple and direct transport of the cleaning web and controls a winding movement of the cleaning web around the wind-up roller.

The driving roller of the present invention enables an accurate transport of the cleaning web, which is independent of the amount of cleaning web, which is wound up on the wind-up roller or on the supply roller. Furthermore the driving roller enables an accurate transport of the cleaning web, which is independent of the thickness of the cleaning web.

While the surface of the driving roller is urged against said portion of the cleaning web, frictional forces between said surface of the driving roller and said portion of the cleaning web in the web transport pinch provide control over the transport of the cleaning web. The surface of the driving roller may be suitably selected in order to enhance said frictional forces and support the control over the transport of the cleaning web.

In particular said surface of the driving roller may be a circumferential surface, which in operation is urged against the portion of the cleaning web. The circumferential surface supports a controlled, predictable and substantially constant transport distance of the cleaning web in case the driving roller is rotated over a certain angle.

In an embodiment of the cleaning web unit, the cleaning web is a cleaning web for cleaning a rotatable member and the cleaning web comprises a cleaning portion, which is in operation urged in contact with a surface of the rotatable member in a cleaning area. The cleaning web may be suitably selected to clean the surface of the rotatable member. A person skilled in the art may select the cleaning web based on the contamination to be removed from the surface of the rotatable member. The cleaning area is the area in which the cleaning portion contacts the surface of the rotatable member. The cleaning area may be suitably adapted. For example the cleaning area may be enlarged, the cleaning area may be moved along the surface, etc.), The surface of the rotatable member may be moved with respect to the cleaning area and/or the cleaning web may be moved with respect to the cleaning area. By moving the cleaning web with respect to the cleaning area the cleaning portion is (at least partially) refreshed; i.e. the cleaning portion is replaced by a different cleaning portion of the cleaning web. The cleaning portion provides an effective means for cleaning the surface of the rotatable member in the cleaning area.

In an embodiment of the cleaning web unit, the driving roller forms the web transporting pinch in conjunction with the wind-up roller and the driving roller is adapted for driving the wind-up roller. In this embodiment said portion of the cleaning web is arranged in the web transport pinch. In case the driving roller is rotated, the driving roller transports the cleaning web in conjunction with the wind-up roller and at the same time drives the wind-up roller. The frictional forces of the surface of the driving roller drives said portion of the cleaning web and accordingly a frictional force between said portion of the cleaning web and the wind-up roller drives the rotation of the wind-up roller. The advantage is that the driving of the wind-up roller is substantially independent of the amount of the cleaning web which is wound-up around the wind-up roller. Furthermore this provides a simple structure as no additional pinch rollers are needed for transporting the cleaning web.

In an embodiment of the cleaning web unit, the web supply mechanism comprises a supply roller, which supply roller supports the cleaning web at another end in the form of a roll of cleaning web, wherein said driving roller forms the web transporting pinch in conjunction with the supply roller and the driving roller is adapted for driving the supply roller. In case the driving roller is rotated, the driving roller transports the cleaning web in conjunction with the supply roller and at the same time drives the rotation of the supply roller, thereby controllably unwinding the cleaning web from the supply roller. Furthermore this provides a simple structure as no additional pinch rollers are needed for transporting the cleaning web.

In an embodiment of the cleaning web unit, the cleaning web unit further comprises a pinch roller and wherein the driving roller forms the web transporting pinch in conjunction with said pinch roller. In case the driving roller is rotated, the driving roller transports the cleaning web in conjunction with the pinch roller. The pinch roller and the driving roller can be arranged anywhere in the cleaning web unit along the cleaning web for forming said web transporting pinch. In an example the pinch roller may be a backing roller.

In an embodiment of the cleaning web unit, the driving roller is spring loaded towards the wind-up roller. This enhances the control of the driving roller on the rotation of the wind-up roller, for example by increasing the frictional forces in between the driving roller and the wind-up roller.

In an embodiment of the cleaning web unit, said portion of the cleaning web is a portion of the cleaning web, which is wound-up around the wind-up roller. In this embodiment the driving roller forms a web transport pinch in conjunction with the wind-up roller and said portion of the cleaning web, which is wound-up around the wind-up roller, is arranged in the web transport pinch. A pinch distance in the web transport pinch may be adjusted in response to the thickness of said portion of the cleaning web. This provides an accurate control on the transport of the cleaning web, thereby winding the cleaning web around the wind-up roller.

In an embodiment of the cleaning web unit, the cleaning web unit further comprises a control unit for controllably rotating the driving roller, wherein the control unit is configured to transport the cleaning web intermittently by means of rotation of the driving roller. The control unit may transport the cleaning web intermittently, each refreshing step being carried out in response to a web refreshing signal. Said web refreshing signal may be based on a sensor signal related to a cleaning web condition (in particular of the cleaning portion), may be based on a sensor signal related to a surface condition of the rotatable member, may be based on a cycle number of the rotatable member, may be based on a time interval attribute and may be based on any other information. The control unit provides a simple and adjustable control over the rotation of the driving roller.

In an embodiment of the cleaning web unit, the driving roller is mounted on a driving axis, wherein a turning lever is connected to the driving axis by means of a one way gear, the turning lever being in operation adapted to rotate the driving axis, thereby rotating the driving roller, wherein the turning lever is biased towards a nominal rotational position. The driving axis may extend in substantially the same direction as the driving roller extends. The driving axis may extend over a longer distance than the driving roller. The driving axis may be supported at one end and may be supported at both ends of the driving axis. The turning lever may be extending in a direction, which is substantially perpendicular to the driving axis. The one way gear rotates the driving axis in case the turning lever is moved in a first direction and the one way gear does substantially not rotate the driving axis in case the turning lever is moved in a backwards direction opposite to the first direction. This embodiment provides a simple mechanical control on the rotation of the driving roller.

In a further embodiment of the cleaning web unit, the cleaning web unit further comprises a cam element, which cam element is rotationally movably arranged and is in operation adapted for rotating the turning level and accordingly the driving roller over a predetermined angle by a rotation of the cam element. The cam element may rotate the driving roller over the predetermined angle by a full turn of the cam element (i.e. angle 360°). Alternatively the cam element may rotate the driving roller over the predetermined angle by a portion of a full turn of the cam element (i.e. angle is smaller than 360°). In a subsequent step the cam element may be rotated backwards to an initial rotational position of the cam element. At the same time the driving roller is not rotated as the one way gear is freely rotatable in said backwards rotational direction. In an embodiment the cam element may comprise one protrusion adapted for rotating the turning lever and accordingly the driving roller over a predetermined angle with respect to the driving axis. In an embodiment the cam element may comprise at least two protrusions, each protrusion being adapted for rotating the turning lever and accordingly the driving roller over a predetermined angle with respect to the driving axis. Said predetermined angle in response to a first protrusion may be different from said predetermined angle in response to a second protrusion.

In an embodiment of the cleaning web unit, the cleaning web unit further comprises a backing roller, which backing roller in operation urges the cleaning portion against a surface of the rotatable member to be cleaned. The backing roller enhances control over the size and position of the cleaning portion and/or of the cleaning area.

In an embodiment of the cleaning web unit, the web supply mechanism comprises a supply roller, which supports the cleaning web at another end. The supply roller may support the cleaning web in a rolled form, wherein a part of the cleaning web is wound around the supply roller. This embodiment provides a compact storage of the cleaning web by the web supply mechanism.

In an embodiment of the cleaning web unit, the supply roller further comprises an unwinding restraining mechanism adapted for providing a web tension in the cleaning web between the supply roller and the wind-up roller. This embodiment supports control on the cleaning portion of the cleaning web in the cleaning area as the cleaning web is stationary and supports accurate control over transport of the cleaning web between the supply roller and the wind-up roller.

In another aspect of the present invention a method is provided for transporting a cleaning web, wherein the method comprises the steps of: providing the cleaning web, wherein the cleaning web is supported at one end by a wind-up roller and is supported at another end by a supply roller; urging a driving roller against a portion of the cleaning web, the driving roller forming a web transporting pinch; and rotating the driving roller in order to transport the cleaning web through the web transporting pinch, thereby winding the cleaning web around the wind-up roller.

The cleaning web is supported at one end by the wind-up roller. Said one end of the cleaning web may be fixed to the wind-up roller. The driving roller is urged against said portion of the cleaning web in the web transporting pinch. The driving roller is rotated in order to controllably transport the cleaning web. As a result in conjunction with the wind-up roller the cleaning web is wound around the wind-up roller.

The driving roller may be intermittently driven thereby intermittently transporting the cleaning web. The driving roller may be rotated in response to a web refreshing signal. Said web refreshing signal may be provided by a control unit, e.g. based on a time interval and/or on a cleaning signal. The driving roller may be rotated over a substantially constant angle for each driving step. Accordingly the cleaning web is transported over a substantially constant distance for each respective driving step.

In an embodiment of the method, in the urging step the driving roller forms a web transporting pinch in conjunction with the wind-up roller and the rotating step further comprises the rotating driving roller driving the wind-up roller. In this step the driving roller may be urged against the portion of the cleaning web and form a web transport pinch in conjunction with the wind-up roller. During the rotating step of the driving roller at the same time the rotating driving roller drives the wind-up roller in the web transport pinch.

In an embodiment of the method, the rotating step comprises rotating the driving roller intermittently in response to a web refreshing signal.

In an embodiment of the method, the rotating step comprises rotating the driving roller over a predetermined angle, thereby moving the cleaning web over a predetermined distance. This supports a simple prediction of the end of life of the cleaning web based on a known relationship between the predetermined angle and the predetermined distance.

In an embodiment of the method, wherein the method further comprises the step of: arranging a cleaning portion of the cleaning web in contact with a surface of a rotatable member in a cleaning area. This supports the cleaning of the surface of the rotatable member.

In another aspect of the present invention, a printing apparatus is provided for printing an image on a recording material, the printing apparatus comprising a cleaning web unit in accordance with the present invention.

### BRIEF DESCRIPTION OF THE DRAWINGS

Hereinafter, the present invention is further elucidated with reference to the appended drawings showing non-limiting embodiments and wherein

FIG. 1 shows a schematic view of a print engine in which a method according to the invention may be used.

FIG. 2A shows a fuser belt and a cleaning web unit according to the invention.

FIG. 2B shows an image forming element and a cleaning web unit according to the invention.

FIG. 3A shows a cleaning web unit in a first state.

FIG. 3B shows a cleaning web unit in a second state.

FIG. 4A-FIG. 4B show a cleaning web unit and a rotatable member in an embodiment of a method according to the present invention.

FIG. 4C shows a cleaning web unit and a rotatable member in an embodiment of a method according to the present invention.

FIG. 5A shows a driving roller of a cleaning web unit according to an embodiment.

FIG. 5B shows a driving roller of a cleaning web unit according to an embodiment.

FIG. 6A shows a printing apparatus and a cleaning web unit according to an embodiment of the invention.

FIG. 6B shows an image forming element and the cleaning web unit of FIG. 6A according to the invention.

### DETAILED DESCRIPTION OF EMBODIMENTS

The present invention will now be described with reference to the accompanying drawings, wherein the same reference numerals have been used to identify the same or similar elements throughout the several views.

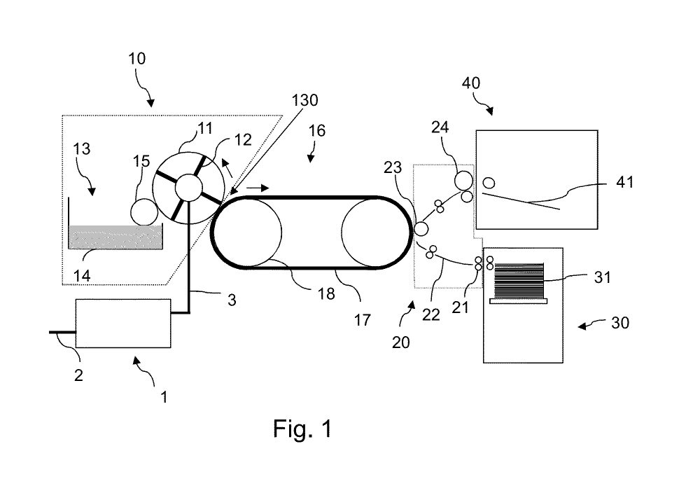

FIG. 1 shows a print engine for printing images. The print engine comprises a converter 1 to convert image data into a print signal, an image forming module 10 to apply marking material corresponding to the print signal, the marking material being brought in contact with the image forming element 11 by a developing unit 13, an intermediate member 16 for transferring the marking material to the image fixing module 20, an image receiving member input station 30 for bringing in an image receiving member, usually sheets of recording media, and a delivery station 40 for receiving the finished output product. In this embodiment the marking material is conventionally toner, which comprises a resin that is softened by heat.

The image data are supplied to the print engine through a data connection 2. This may be any suitable data connection, depending among other things on the required bandwidth. The digital image converter 1 comprises electronic circuits including programmable logic to convert an image line into a print signal that is suitable to be applied to the image forming module 10 through a data connection 3. In FIG. 1 the image forming module 10 comprises a rotatable, substantially cylindrically shaped image forming element 11 having an electronic device 12 in the inside to apply a voltage on conductive tracks under a dielectric layer on an outer surface of the image forming element. The developing unit 13 comprises a toner supply unit 14 and a developing roller 15. Said voltage applied to the conductive tracks of the image forming element 11 induces a local electric field outside the image forming element that attracts toner particles from developing roller 15 that receives the toner particles from a toner supply unit 14. In this way an image of toner particles is formed on the surface of the image forming element 11.

Alternatively the image forming element 11 may comprise a roller or a belt with a photoconductive layer on the outside surface of the roller. In such embodiment the surface of the photoconductive layer is charged by e.g. a corona and the print signals are applied to an imaging unit outside the roller. The imaging unit may comprise a LED-bar, or a laser scan module, that locally illuminates the layer conform the image to be printed. The photoconductivity of the layer results in a locally discharged surface. The parts of the photoconductive layer that remain charged may be used to attract toner from a toner roller like developing roller 15 by creating an electric field between these charged parts and the toner roller. In an embodiment an electric field between the charged parts and the toner roller may be provided by connecting the toner roller to a ground voltage. The toner may comprise electrically conductive particles having a specified color or a mixture of isolating colored particles and carrier particles that charge the isolating particles, making them sensitive to an electric field between the developing roller and the image forming element. Instead of carrier particles the developing roller may also be supplemented by a contact roller that charges the toner particles. Therefore there are various ways to obtain an image of toner particles on the surface of the image forming element. In the process of forming the image the element rotates in the direction indicated by the arrow in FIG. 1. It is further noted that in another embodiment, an imaging forming element is formed by arranging a belt with a photoconductive layer on several rollers.

The intermediate member 16 comprises a belt 17 and two guiding rollers 18, but more rollers are also possible. The belt 17 rotates in congruence with the image forming element 11 and receives the toner image in a nip 130 where the image forming element 11 and the belt 17 are in contact. The transfer of toner may take place by the influence of mechanical forces that are induced when the top layer of the belt comprises an elastic, adhesive material, such as rubber, or by the influence of electric forces that originate from a voltage difference between the image forming element and the belt. The intermediate member 16 may further comprise a heating unit, which is not shown in FIG. 1, to control the temperature of the belt. Although only one image forming element is shown in FIG. 1, the intermediate member may be configured to have several image forming elements around it, each for a different process color of toner particles, which are collected on the belt. In this way a full color image may be formed, e.g. by the process colors cyan, magenta, yellow and black. The intermediate member may also be configured as a drum with an outer layer that is suitable to collect the various color particles.

The image fixing module 20 is able to transport an image receiving member, such as a sheet of paper, by transport rollers 21 and guiding means 22 to a pressure roller 23 that brings the image receiving member into contact with the belt 17 of the intermediate member 16. The image receiving member is supplied by an image receiving member input station 30 comprising a pile of sheets 31. By applying heat and pressure the toner is brought onto the image receiving member, which is transported further towards the post processing unit 40. The image fixing module may comprise a path for turning the image receiving member to be able to print another side. The fuser rollers 24 raise the temperature of the image receiving member to further fix the printed image on the image receiving member and to enhance the printed image quality. When the temperature of the pressure roller 23 is sufficiently high, no fuser rollers are necessary.

The post processing unit 40 is shown as a support tray 41, on which different sheets may be stacked, but may also comprise a stapler, a hole puncher etc. for performing a post processing step. The various modules are controlled by a control unit to have their actions coordinated.

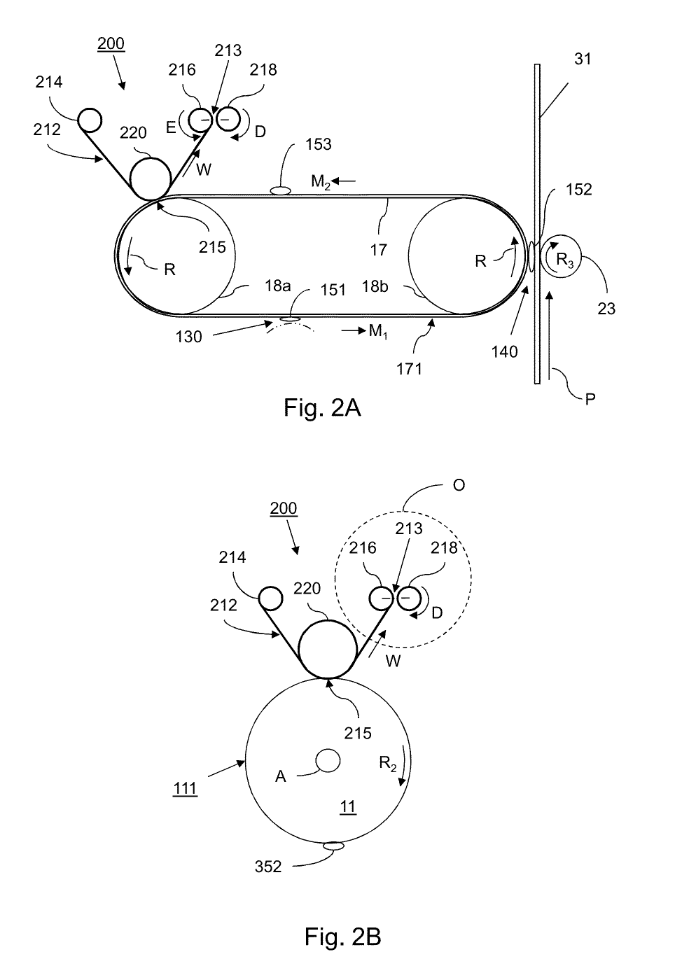

FIG. 2A shows a belt and a cleaning web unit according to the invention. The belt 17 comprises a surface layer 171. The belt 17 is driven by a first guiding roller 18a at a first end and a second guiding roller 18b at a second end. The belt 17 forms together with the first guiding roller 18a and a pressure roller 23 a transfuse nip 140. The pressure roller 23 brings the recording medium 31 into contact with the belt 17. The pressure roller 23 is rotatably arranged as indicated by arrow R₃. A recording medium 31 is transported through the transfuse nip 140 in a direction P.

A marking material 151 is transferred towards the belt 17 by an image forming element (not shown), for example an image drum 11 as shown in FIG. 1, in an image transfer nip 130 for transferring the marking material 151 (or transferring an image constituted by the marking material 151) from the image forming element to the belt 17. An image comprising a marking material 151, which has been transferred from to the surface layer 171 of the fuser belt, is transported by the belt 17 to the transfuse nip 140 as indicated by arrow M₁. In the transfuse nip 140 a marking material 152 is transferred, and optionally fused, to the recording medium 31.

Due to an incomplete transfer of an image constituted by the marking material 151 part of the marking material is not transferred to the recording medium 31 in the transfuse nip 140 and will still be present on the belt 17 as indicated with marking material 153, which marking material 153 is transported by the belt 17 towards a cleaning web unit 200 as indicated by arrow M₂.

The cleaning web unit 200 comprises a cleaning web 212, a supply roller 214, a wind-up roller 216 and a backing roller 220. The cleaning web 212 is attached to the supply roller 214 on one end and is supported by the supply roller 214 in the form of a roll of cleaning web 212. The cleaning web 212 is attached to the wind-up roller on another end of the cleaning web 212. The cleaning web 212 comprises a cleaning portion which in operation is arranged in contact with the belt 17 in a cleaning area 215. The backing roller 220 urges the cleaning portion against the belt 171 in the cleaning area 215.

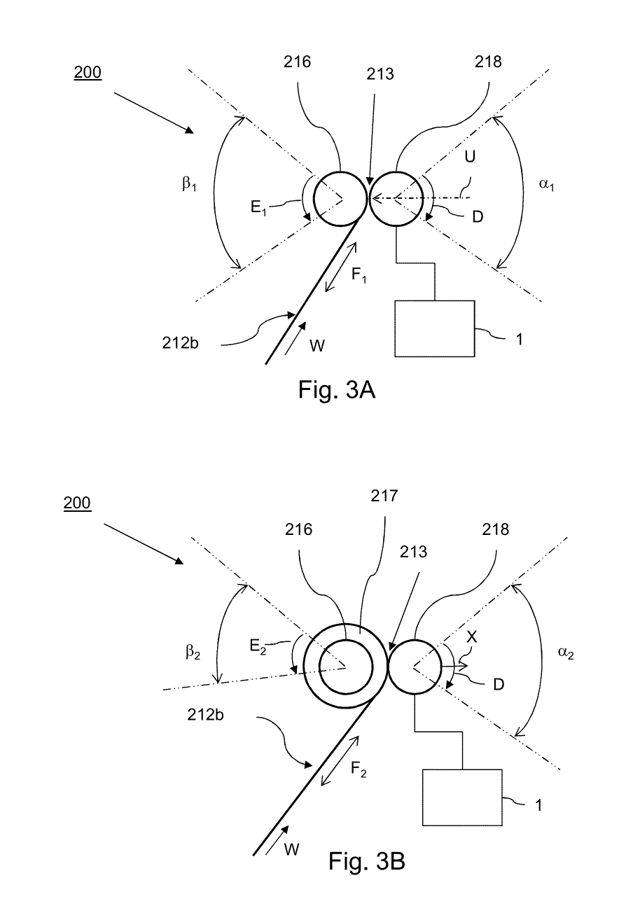

A driving roller 218 is urged against a portion of the cleaning web 212 in a web transporting pinch 213, which is formed by the driving roller 218 in conjunction with the wind-up roller 216. The driving roller 218 is rotated in a direction according to arrow D, thereby transporting the cleaning web 212 in a direction according to arrow W. At the same time the driving roller 218 drives the wind-up roller in a direction according to arrow E, thereby winding the cleaning web 212 around the wind-up roller 216. A more detailed explanation of the transport and winding of the cleaning web 212 in the cleaning web unit 200 is illustrated in FIG. 3A and FIG. 3B.

FIG. 2B shows an image forming element and a cleaning web unit according to the invention. The image forming unit 11 is rotated around axis A in a direction according to arrow R₂. The image forming unit 11 has an outer surface 111 on which a marking material 352 is developed. The marking material 352 is transferred to a recording material or to an intermediate image carrier in a transfer nip (not shown). In case the marking material 352 is not transferred in the transfer nip, the marking material is transported to a web cleaning unit 200. The cleaning web unit 200 is the same as the cleaning web unit 200 shown in FIG. 2A. The cleaning web 212 comprises a cleaning portion which in operation is arranged in contact with the image forming element 11 in a cleaning area 215. The backing roller 220 urges the cleaning portion against the image forming element 11 in the cleaning area 215.

A more detailed explanation of the transport and winding of the cleaning web 212 in the cleaning web unit 200 is illustrated in FIG. 3A and FIG. 3B for detail O of the cleaning web unit 200.

FIG. 3A shows a cleaning web unit in a first state. FIG. 3A shows the detail O of the cleaning web unit 200. In the first state of the cleaning web unit 200 the driving roller 218 is spring loaded towards the wind-up roller according to arrow U. The driving roller 218 and the wind-up roller 216 together form a web transport pinch 213. The driving roller 218 is urged against a portion of the cleaning web 212, which is arranged in the web transport pinch 213. A control unit 1 is operatively connected to the driving roller 218 for driving the driving roller 218 (i.e. controllably rotating the driving roller 218). In the first state of the cleaning web unit 200 substantially no cleaning web is wound around the wind-up roller 216. In case the driving roller 218 is rotated in a direction according to arrow D, the cleaning web 212 is transported in a direction according to arrow W₁ and the wind-up roller is rotated in a direction according to arrow E₁. In the first state the driving roller 218 is rotated over an angle α₁, which is substantially equal to the wind-up roller being rotated over an angle β₁, while the cleaning web 212 is transported in the direction W over a distance F₁.

FIG. 3B shows the cleaning web unit of FIG. 3A in a second state. In the second state of the cleaning web 200 the wind-up roller 216 supports a wound-up portion of the cleaning web 217. The wind-up roller 216 including the wound-up portion of the cleaning web 217 has an increased total diameter and an increased circumference with respect of the wind-up roller 216 in FIG. 3A. The driving roller 218 is still spring loaded towards the wind-up roller 216, but has moved in a direction X over a distance in response to a thickness of the wound-up portion of the cleaning web 217 on the wind-up roller 216. In case the driving roller 218 is rotated in a direction according to arrow D, the cleaning web 212 is transported in a direction according to arrow W and the wind-up roller is rotated in a direction according to arrow E₂. In the second state the driving roller 218 is rotated over an angle α₂, and the wind-up roller 216 is rotated over an angle β₂ in conjunction with the driving roller 218. The cleaning web 212 is transported in the direction W over a distance F₂ in response to the angle α₂. The angle α₂ of the second state is equal to the angle α₁ of the first state and the angle β₂ is smaller than the angle β₁. The distance F₂ is equal to the distance F₁ of the first state. A distance F(α) is equal for each transport step of the cleaning web 212 as long as the angle α of the driving roller 218 for each transport step is constant. The distance F(a) is constant and is independent of the amount of wound-up portion of the cleaning web 217, which is wound around the wind-up roller 216. At the same time the angle β of the wind-up roller 216 may decrease for each following transport step according to the increasing circumference of the wind-up roller 216 including the wound-up portion of the cleaning web 217.

The illustration of the first and second state of the cleaning web unit 200 is independent of the use of the cleaning web; it is also applicable to the use for cleaning a belt 17 as shown in FIG. 2A and may be used to clean any other rotatable member.

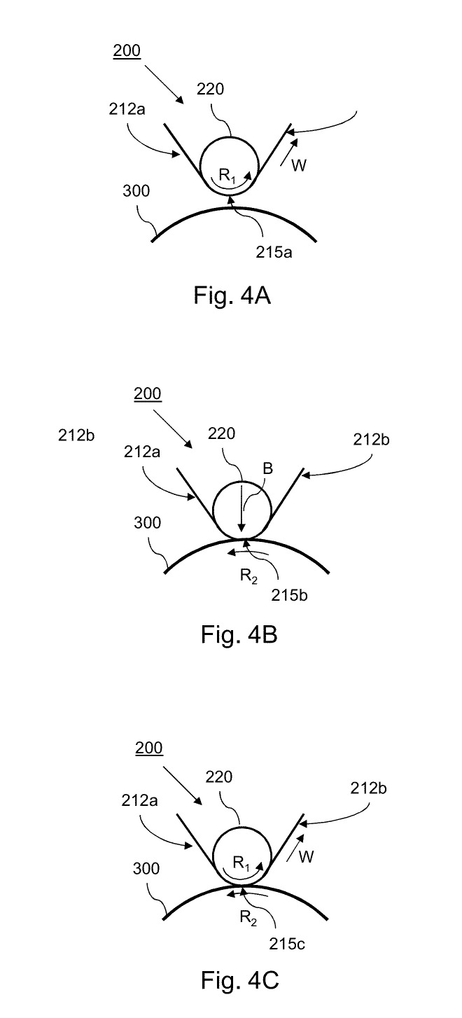

FIG. 4A-FIG. 4B show a cleaning web unit and a rotatable member in an embodiment of a method according to the present invention. In the present embodiment shown in FIG. 4A-4B the cleaning web is stationary with respect to the rotatable member during a cleaning action of the surface of the rotatable member (as shown in FIG. 4B).

In FIG. 4A a detail of the cleaning web unit 200 is shown, comprising the cleaning web and a backing roller 220. The cleaning web comprises a cleaning portion 215a, a first portion 212a and a second portion 212b. The cleaning portion 215a is arranged free from contact with a rotatable member 300 (which may be a belt 17 or may be an image forming unit 11 or any other rotatable member). The cleaning portion 215a is refreshed in a refreshment step of the method by moving the cleaning portion 215a (including the first portion 212a and the second portion 212b) in the direction of arrows R₁ and of arrow W. As a result a part of the first portion 212a forms now the cleaning portion 215b (as shown in FIG. 4B).

In FIG. 4B the backing roller is moved in the direction of arrow B and urges a fresh cleaning portion 215b against the rotatable member 300. The rotatable member 300 is rotated in the direction R₂, while the cleaning web (including the cleaning portion 215b) is held fixed with respect to the rotatable member 300. Any contamination which is present on the outer surface of the rotatable member may be transferred onto the cleaning portion 215b of the cleaning web 212. As such by the rotation of the rotatable member provides a cleaning action for cleaning the outer surface of the rotatable member.

FIG. 4C shows a cleaning web unit and a rotatable member in an embodiment of a method according to the present invention. In the present embodiment shown in FIG. 4C the cleaning web may be stationary in one state and may be moving in another state with respect to the rotatable member during a cleaning action of the surface of the rotatable member. In FIG. 4C a detail of the cleaning web unit 200 is shown, comprising the cleaning web and a backing roller 220. The cleaning web comprises a cleaning portion 215c, a first portion 212a and a second portion 212b. The cleaning portion 215c is arranged in contact with a rotatable member 300 (which may be a belt 17 or may be an image forming unit 11 or any other rotatable member) in a cleaning area by urging the backing roller 220 towards the rotatable member 300. The cleaning area is defined as the area of contact between the cleaning web and the rotatable member 300. The cleaning portion 215c may be intermittently refreshed by stepwise moving the cleaning portion 215c (including the first portion 212a and the second portion 212b) in the direction of arrows R₁ and W in response to a web refreshing signal. At the same time and in between refreshment of the cleaning portion 215c the rotatable member is moved in the direction of arrow R₂. In between refreshment of the cleaning portion 215c, said cleaning portion 215c is held fixed with respect to the cleaning area. Any contamination which is present on the outer surface of the rotatable member 300 is transferred onto the cleaning portion 215c of the cleaning web.

In the present embodiment the movement of the cleaning portion 215c of the cleaning web in the cleaning area (indicated by arrow R₁) is opposite to the movement of the rotatable member 300 in the cleaning area (indicated by arrow R₂).

Alternatively the movement of the cleaning portion 215c of the cleaning web in the cleaning area is in the same direction as the movement of the rotatable member 300 in the cleaning area.

In an alternative embodiment the cleaning portion 215c may be continuously refreshed by continuously moving the cleaning portion 215c (including the first portion 212a and the second portion 212b) in the direction of arrows R₁ and W, while the cleaning portion 215c is arranged in contact with the rotatable member 300.

In yet another embodiment (not shown) the cleaning portion 215c of the cleaning web is urged in contact with the outer surface of the rotatable member and is moved in a direction with respect to the cleaning area while the outer surface of the rotatable member is held stationary with respect to the cleaning area.

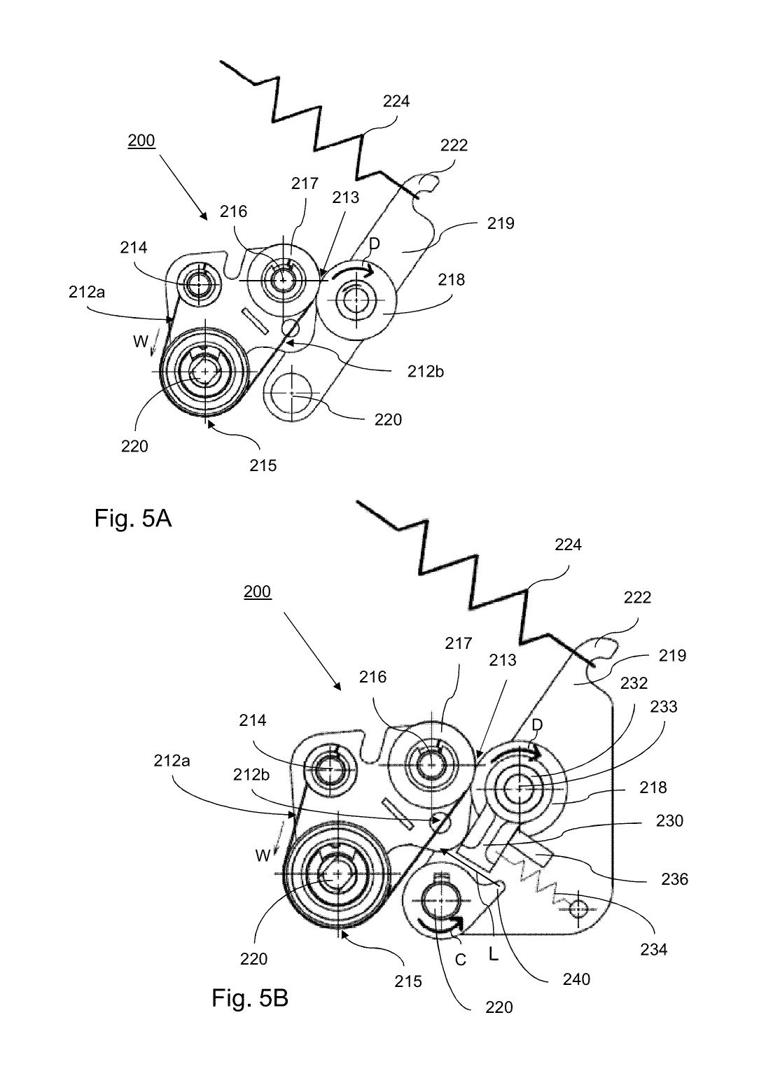

FIG. 5A shows a driving roller of a cleaning web unit according to an embodiment. The cleaning web unit 200 comprises a cleaning web, a supply roller 214, a backing roller 220 and a wind-up roller 216. The cleaning web comprises a first portion 212a upstream of a cleaning portion 215, and a second portion 212b downstream of the cleaning portion 215 of the cleaning web. Upstream and downstream as used herein are relative positions of said respective portion of the cleaning web with respect to the cleaning portion 215 when moving along the cleaning web in the direction as indicated by arrow W. The upstream portion of the cleaning web is an unused part of the cleaning web. The downstream portion of the cleaning web is a used part of the cleaning web. The cleaning web further comprises a wound-up portion 217, which is supported by and wound around the wind-up roller 216. A driving roller 218 is urged against a portion of the cleaning web in a web transport pinch 213, which is formed by the driving roller 218 in conjunction with the wind-up roller 216. The driver roller 218 extends in a direction perpendicular to the plane of viewing of the FIG. 5A and is supported at each end by a driving frame 219, which is rotatably movable around an axis 220. The driving frame 219 comprises an upper end portion 222, which is attached to a spring 224. The spring 224 pulls the upper end portion 222 and accordingly the driver roller 218 such that the driver roller 218 is urged towards the wind-up roller 216. The driving roller 218 may be rotated in the direction D in order to controllably transport the cleaning web 212 in the web transport pinch 213. The driving roller 218 is stepwise rotated by a driving motor (not shown), which comprises an encoder. The encoder is used to determine the angle of rotation of the driving roller 218. As such the angle of rotation of the driving roller 218 may be accurately controlled.

FIG. 5B shows a driving roller of a cleaning web unit according to an embodiment. The embodiment is similar to the embodiment shown in FIG. 5A. In the present embodiment the driving roller 218 is mounted on a driving axis 233. A turning lever 230 is connected to the driving axis 233 by means of enclosing a one way gear 232.

The cleaning web unit 200 comprises a cleaning web, a supply roller 214, a backing roller 220 and a wind-up roller 216. The cleaning web comprises a first portion 212a upstream of a cleaning portion 215, and a second portion 212b downstream of the cleaning portion 215 of the cleaning web. Upstream and downstream as used herein are relative positions of said respective portion of the cleaning web with respect to the cleaning portion 215 when moving along the cleaning web in the direction as indicated by arrow W. The cleaning web further comprises a wound-up portion 217, which is supported by and wound around the wind-up roller 216. A driving roller 218 is urged against a portion of the cleaning web in a web transport pinch 213, which is formed by the driving roller 218 in conjunction with the wind-up roller 216. The driver roller 218 extends in a direction perpendicular to the plane of viewing of the FIG. 5A and is supported by the driving axis 233. The driving axis 233 is supported at each end by a driving frame 219, which driving frame 219 is rotatably movable around an axis 220. The driving frame 219 comprises an upper end portion 222, which is attached to a spring 224. The spring 224 pulls the upper end portion 222 and accordingly the driver roller 218 such that the driver roller 218 is urged towards the wind-up roller 216.

The turning lever 230 and the one way gear 232 are adapted to rotate the driving axis 233 and the driving roller 218 in one of the rotational directions only. In case the turning lever 230 is moved in a direction of arrow L, the driving axis is rotated. In case the turning lever 230 is moved in a direction opposite to arrow L, the driving axis 233 is not rotated. The turning lever 230 is urged against a positioning element 236 by ways of spring element 234, which is connected to the turning lever 230. Both positioning element and spring element 234 are supported by the driving frame 219.

A cam element 240 is rotatable movably supported by the axis 220. In case the axis 220 is rotated, the cam element 240 is likewise rotated around axis 220. The cam element 240 is adapted to rotate the turning lever 230 over a predetermined angle around driving axis 233, during a rotation of the cam element 240 around the axis 220 in the direction C. As such the driving roller 218 may be controllably rotated in the direction D over the predetermined angle due to the mechanism of the cam element 240 and the turning level 230.

The cam element 240 may be rotated over a full turn (i.e. angle 360°) in the direction C in order to rotate the driving roller 218 over the predetermined angle. Alternatively the cam element 240 may be rotated over a portion of a full turn (e.g. an angle 45°) in the direction C thereby rotating the driving roller 218 over the predetermined angle. Subsequently the cam element 240 may be rotated backward in a direction opposite to the direction C (e.g. angle −45°) towards an initial position of the cam element 240, thereby (temporarily) moving the turning lever 230 in a direction opposite to the direction L, while not rotating the driving roller 218 due to the freely rotatable one way gear 232 in said rotational direction opposite to the direction D.

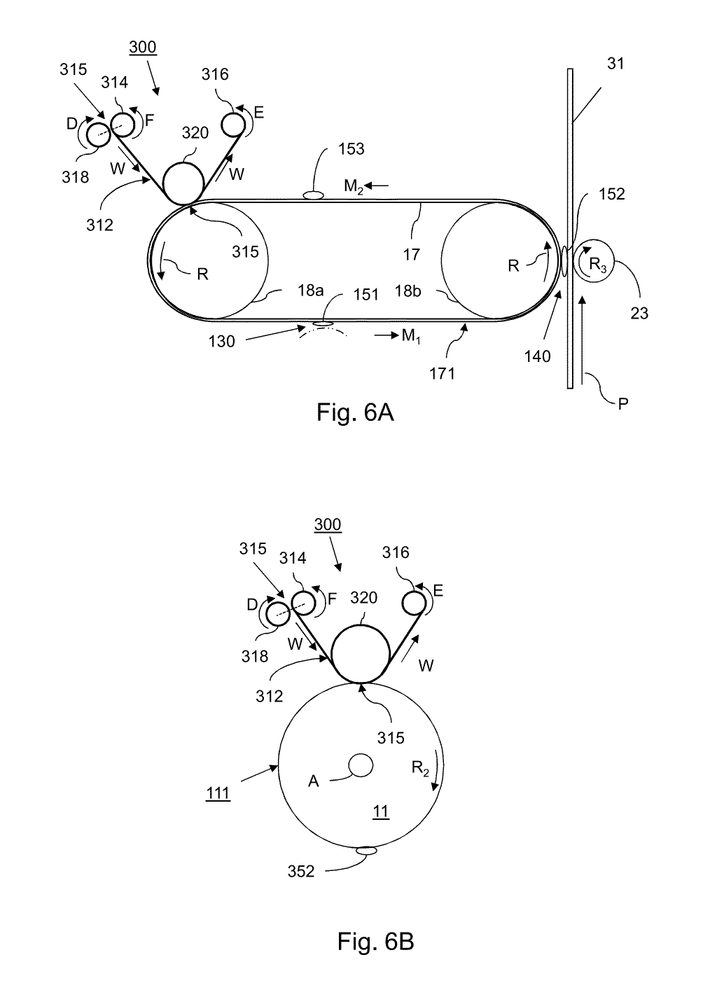

FIG. 6A shows a printing apparatus and a cleaning web unit according to an embodiment of the invention. The printing apparatus is similar to the printing apparatus shown in FIG. 2A. A belt 17 comprises a surface layer 171. The belt 17 is driven by a first guiding roller 18a at a first end and a second guiding roller 18b at a second end. The belt 17 forms together with the first guiding roller 18a and a pressure roller 23 a transfuse nip 140. The pressure roller 23 brings the recording medium 31 into contact with the belt 17. The pressure roller 23 is rotatably arranged as indicated by arrow R₃. A recording medium 31 is transported through the transfuse nip 140 in a direction P. A marking material 151 is transferred towards the belt 17 by an image forming element (not shown), for example an image drum 11 as shown in FIG. 1, in an image transfer nip 130 for transferring the marking material 151 (or transferring an image constituted by the marking material 151) from the image forming element to the belt 17. An image comprising a marking material 151, which has been transferred from to the surface layer 171 of the fuser belt, is transported by the belt 17 to the transfuse nip 140 as indicated by arrow M₁. In the transfuse nip 140 a marking material 152 is transferred, and optionally fused, to the recording medium 31.

Due to an incomplete transfer of an image constituted by the marking material 151 part of the marking material is not transferred to the recording medium 31 in the transfuse nip 140 and will still be present on the belt 17 as indicated with marking material 153, which marking material 153 is transported by the belt 17 towards a cleaning web unit 300 as indicated by arrow M₂.

The cleaning web unit 300 comprises a cleaning web 312, a supply roller 314, a wind-up roller 316 and a backing roller 320. The cleaning web 312 is attached to the wind-up roller 316 on one end of the cleaning web 312. The cleaning web 312 is attached to the supply roller 314 on another end of the cleaning web 312 and is supported by the supply roller 314 in the form of a roll of cleaning web 312. The cleaning web 312 comprises a cleaning portion which in operation is arranged in contact with the belt 17 in a cleaning area 315. The backing roller 320 urges the cleaning portion against the belt 171 in the cleaning area 315.

A driving roller 318 is urged against a portion of the cleaning web 312 in a web transporting pinch 315, which is formed by the driving roller 318 in conjunction with the supply roller 314. The driving roller 318 is rotated in a direction according to arrow D, thereby transporting the cleaning web 312 in a direction according to arrow W. At the same time the driving roller 318 drives the supply roller 314 in a direction according to arrow F, thereby unwinding the cleaning web 312 from the supply roller 314.

At the same time (in conjunction) the wind-up roller 316 winds up the cleaning web 312 around said wind-up roller 316 in a direction according to arrow E due to a pre-tension spring pulling on said end of the cleaning web 312 and rotating the wind-up roller 316 in said direction according to arrow E. Said pre-tension spring is adjusted such that the wind-up roller 316 is only rotated in case the driving roller 318 transports the cleaning web 312 in the direction W.

FIG. 6B shows an image forming element and the cleaning web unit of FIG. 6A according to the invention. The image forming unit 11 is rotated around axis A in a direction according to arrow R₂. The image forming unit 11 has an outer surface 111 on which a marking material 352 is developed. The marking material 352 is transferred to a recording material or to an intermediate image carrier in a transfer nip (not shown). In case the marking material 352 is not transferred in the transfer nip, the marking material is transported to a web cleaning unit 300. The cleaning web unit 300 is the same as the cleaning web unit 300 shown in FIG. 6A. The cleaning web 312 comprises a cleaning portion which in operation is arranged in contact with the image forming element 11 in a cleaning area 315. The backing roller 320 urges the cleaning portion against the image forming element 11 in the cleaning area 315.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A cleaning web unit, the cleaning web unit comprising:
a cleaning web;
a web supply mechanism for supplying the cleaning web;
a wind-up roller which supports the cleaning web at one end and is adapted for winding the cleaning web around the wind-up roller;
a driving roller having a surface which in operation is urged against a portion of the cleaning web, the driving roller being adapted for transporting the cleaning web, thereby winding the cleaning web around the wind-up roller, wherein the driving roller forms a web transporting pinch and wherein the driving roller is urged against said portion of the cleaning web in said web transporting pinch.

2. The cleaning web unit according to claim 1, wherein the driving roller forms the web transporting pinch in conjunction with the wind-up roller and wherein the driving roller is adapted for driving the wind-up roller.

3. The cleaning web unit according to claim 1, wherein the web supply mechanism comprises a supply roller, which supply roller supports the cleaning web at another end in the form of a roll of cleaning web, and wherein the driving roller forms the web transporting pinch in conjunction with the supply roller and wherein the driving roller is adapted for driving the supply roller.

4. The cleaning web unit according to claim 1, wherein the cleaning web unit further comprises a pinch roller and wherein the driving roller forms the web transporting pinch in conjunction with said pinch roller.

5. The cleaning web unit according to claim 3, wherein the driving roller is spring loaded towards the wind-up roller.

6. The cleaning web unit according to claim 3, wherein said portion of the cleaning web is a portion of the cleaning web, which is wound-up around the wind-up roller.

7. The cleaning web unit according to claim 1, wherein the cleaning web unit further comprises a control unit for controllably rotating the driving roller, wherein the control unit is configured to transport the cleaning web intermittently by means of rotation of the driving roller.

8. The cleaning web unit according to claim 1, wherein the driving roller is mounted on a driving axis, wherein a turning lever is connected to the driving axis by means of a one way gear, the turning lever being in operation adapted to rotate the driving axis, thereby rotating the driving roller, wherein the turning lever is biased towards a nominal rotational position.

9. The cleaning web unit according to claim 8, wherein the cleaning web unit further comprises a cam element, which cam element is rotationally movably arranged and is in operation adapted for rotating the turning level and accordingly the driving roller over a predetermined angle by a rotation of the cam element.

10. The cleaning web unit according to claim 1, wherein the cleaning web is a cleaning web for cleaning a rotatable member and the cleaning web comprises a cleaning portion, which is in operation urged in contact with a surface of the rotatable member in a cleaning area, and wherein the cleaning web unit further comprises a backing roller, which backing roller in operation urges the cleaning portion against the surface of the rotatable member to be cleaned.

11. A method for transporting a cleaning web, wherein the method comprises the steps of:
a) providing the cleaning web, wherein the cleaning web is supported at one end by a wind-up roller and is supported at another end by a supply roller;
b) urging a driving roller against a portion of the cleaning web, the driving roller forming a web transporting pinch; and
c) rotating the driving roller in order to transport the cleaning web through the web transporting pinch, thereby winding the cleaning web around the wind-up roller.

12. The method according to claim 11, wherein in step b) the driving roller forms said web transporting pinch in conjunction with the wind-up roller and the rotating step c) comprises the rotating driving roller driving the wind-up roller.

13. The method according to claim 11, wherein the rotating step c) comprises rotating the driving roller intermittently in response to a web refreshing signal.

14. The method according to claim 11, wherein the rotating step c) comprises rotating the driving roller over a predetermined angle, thereby moving the cleaning web over a predetermined distance.

15. A printing apparatus for printing an image on a recording material, the printing apparatus comprising a cleaning web unit in accordance with claim 1.

16. A printing apparatus for printing an image on a recording material, the printing apparatus comprising a cleaning web unit in accordance with claim 2.

17. A printing apparatus for printing an image on a recording material, the printing apparatus comprising a cleaning web unit in accordance with claim 3.

18. A printing apparatus for printing an image on a recording material, the printing apparatus comprising a cleaning web unit in accordance with claim 4.

19. A printing apparatus for printing an image on a recording material, the printing apparatus comprising a cleaning web unit in accordance with claim 5.

20. A printing apparatus for printing an image on a recording material, the printing apparatus comprising a cleaning web unit in accordance with claim 6.
